(19) United States
(12) Patent Application Publication
(10) Pub. No.: US 2014/0108104 A1
(43) Pub. Date: Apr. 17, 2014

(54) System and Method for Performance Tracking for Motivating Individuals to Capture Consumer Data Via Mobile Devices

(71) Applicants: Alex Stancioff, Coral Gables, FL (US); Milen Iossifov Mishkovsky, Coral Gables, FL (US); Oscar DiVeroli, Plantation, FL (US)

(72) Inventors: Alex Stancioff, Coral Gables, FL (US); Milen Iossifov Mishkovsky, Coral Gables, FL (US); Oscar DiVeroli, Plantation, FL (US)

(21) Appl. No.: 13/651,179

(22) Filed: Oct. 12, 2012

(51) Int. Cl. G06Q 10/00

(52) U.S. Cl. 705/7.42

(57) ABSTRACT

Individual performance for obtaining consumer participation in a promotion is tracked. The individual is associated with a promotion. A URL corresponding the individual/promotion association is generated. The URL is converted to a code such as a QR code, and the QR code is placed on a physical medium that to be carried by the individual. The individual requests a consumer to scan the QR code to participate in the promotion. When the consumer so scans the QR code, metrics are updated to so indicate the user's interest. Metrics are further updates when the user accepts the promotion. The metrics are stored in a database in association with the URL corresponding to the individual/promotion association.

### FIELD

Embodiments relate generally to marketing programs. More specifically, embodiments, relate to tracking individual performance of consumer data collection via Internet (or other network) enabled devices to build a marketing database.

### BACKGROUND

In modern economies, knowledge of consumer data is paramount to success. The more information that can be collected and used pertaining to existing and prospective consumers of goods and/or services, the more significant the competitive advantage. To entice consumers to provide marketing data, promotions are often used. For example, promotions can be targeted to consumers whereby the consumer obtains a benefit for providing the data. The benefits can be virtually anything a consumer may find of value, and may include discounts, valuable messages and notifications, free products or services, the ability to purchase products and services directly from the consumer's device, and other offers.

While there are methods of acquiring consumer data, attempts to communicate direct with these consumers may fail if the method does not include tacit consumer opt-in. For example, where the promotion is sent by email, the consumer may not receive the email. Consequently, other ways of providing promotions to consumers to obtain marketing data that have a higher likelihood of success are desirable.

### SUMMARY

Embodiments enable performance monitoring of individuals who interact with consumers of goods and/or services offered by manufacturers or service providers. In an embodiment, a QR code (or any other contact or contactless data transfer method, including without limitation, NFC, RFID, magnetic strip, and other data transfer methods) is generated and associated with each product or service for which a promotion is to be offered. The generated QR code is also associated with an individual that interacts with the consumer of the goods and/or services offered by the manufacturer or service provider. The promotion can be offered by the individual as an incentive to customers to provide marketing data, also known as “opting in.” In an embodiment, the promotion is provided via an Internet (or other network) enabled device, such as, without limitation, a mobile telephone, computer, computer tablet, or other device. In addition, the performance of the employee in obtaining marketing data is tracked. Employees may receive rewards and/or incentives based on their performance in obtaining marketing data from consumers.

Additional features and embodiments of the present invention will be evident in the following detailed description.

### BRIEF DESCRIPTION OF THE DRAWINGS

FIG. 1 is a flow chart for a method for creating promotions, entering individuals to be tracked, capturing consumer data and measuring individual opt-in capture performance according to an embodiment of the present invention.

FIG. 2 illustrates an exemplary log in web page according to an embodiment of the present invention.

FIG. 3 illustrates an exemplary unique ID entry web page according to an embodiment of the present invention.

FIG. 4A illustrates an exemplary promotion calendar according to an embodiment of the present invention.

FIG. 4B illustrates an exemplary promotion creation web page 410 according to an embodiment of the present invention.

FIG. 5 illustrates a web page for associating promotions with individuals according to an embodiment of the present invention.

FIG. 6 illustrates an exemplary web page showing system-generated URLs for individual/promotion associations or links according to an embodiment of the present invention.

FIG. 7 illustrates a QR code corresponding to a URL according to an embodiment of the present invention.

FIG. 8A illustrates a front of an exemplary plastic card having QR Code to be affixed to or worn by an individual by neck lanyard or other connecting device according to an embodiment of the present invention.

FIG. 8B illustrates an exemplary back of card having QR Code to be affixed to or worn by an individual by neck lanyard or other connecting device according to an embodiment of the present invention.

FIG. 9A illustrates an exemplary welcome web page a consumer sees when the consumer scans a QR code according to an embodiment of the present invention.

FIG. 9B illustrates an exemplary confirmation web page according to an embodiment of the present invention.

FIG. 9C illustrates an exemplary log in web page according to an embodiment of the present invention.

FIG. 9D illustrates an exemplary consumer promotion page according to an embodiment of the present invention.

FIG. 9E illustrates an exemplary reveal promotion web page according to an embodiment of the present invention.

FIG. 10 illustrates an exemplary report web page showing individual performance according to an embodiment.

FIG. 11 is a schematic diagram of an exemplary computer that can be configured to provide the client or server services described herein.

FIG. 12 is a schematic diagram illustrating a system for tracking individual performance in a promotional campaign according to an embodiment of the present invention.

### DETAILED DESCRIPTION

One of the most powerful ways for businesses to remarket to existing or potential consumers is to first capture their unique contact information—most often an email address. This contact information (or opt-in) generally may require some form of an incentive, promotion, or valuable consideration to be offered in exchange. In an embodiment, a QR code is generated and assigned to a product or service. The QR code is also uniquely assigned to an individual who comes into contact with a consumer. For example, the individual may be an employee of a downstream business that sells the product or service. In general, however, the individual can be any person or distinct entity that has direct contact with consumers (i.e., the marketing database target). An exemplary downstream business is a retail business. To obtain the promotion, in an embodiment, the consumer uses an application running on a mobile device, a computer, or other device to scan the QR code.

When the QR code is scanned, the consumer enters a sign in phase. If the consumer is a new user, the consumer enters a registration phase in which the consumer creates an account. As part of registration phase, the consumer selects a user name and password to access the account. In an embodiment, after the account is created, access to the account is then provided to the consumer. In an alternate embodiment, if the consumer is already registered, the consumer accesses a previously created account using the user name and password. In this case, the consumer does not select the new user the registration phase and enters the sign in phase as an existing user. As such, the consumer is requested to enter the user name and password to access the account.

After the consumer accesses the account, the consumer is provided access to the promotion. For example, the promotion may be a discount for joining a loyalty program. The promotion may also be an offer to purchase a discounted product or service via the consumer's mobile device. In an embodiment, the promotion can be redeemed by tapping a redeem button that appears in the display of the mobile device. In an embodiment, upon tapping the redeem button, the consumer may be given the option of either a paid or an unpaid opt-in. A paid opt-in means the consumer purchases a product or service to obtain the promotion.

An embodiment tracks the number of successful interactions (i.e. QR codes scanned by a consumer) on an individual basis, and on a product or service basis.

Entities that employ embodiments of the present invention are able to regularly track the performance of both promotions and individuals. Businesses then compensate the individuals based on their own internal procedures.

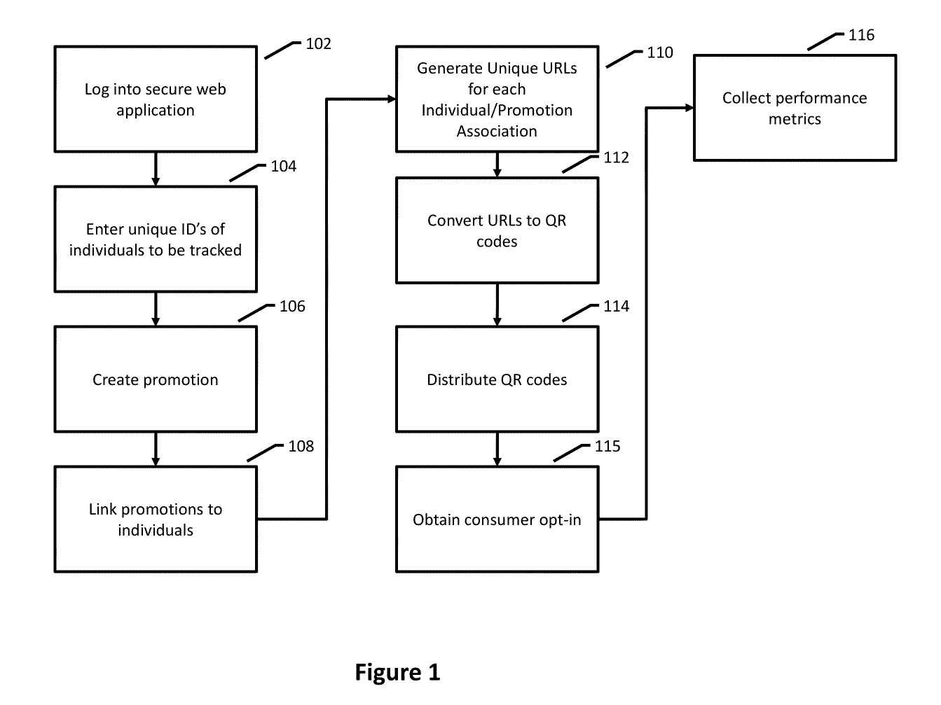

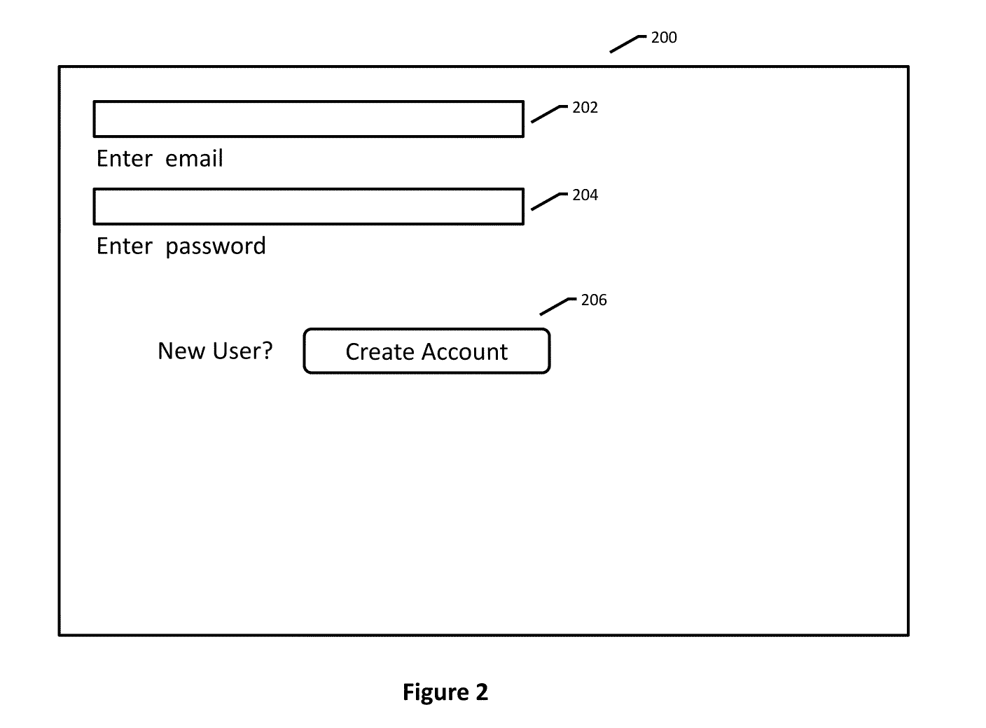

FIG. 1 is a flow chart for a method for tracking individuals based on their level of opting-in consumers and on their performance in general. In step 102, a secure web application is logged into by, for example, a user desiring to offer promotions to consumers through individuals. In an embodiment for example, the user is a merchant who desires to offer promotions to consumers through individuals as described herein. FIG. 2 illustrates an exemplary log in web page 200 according to an embodiment of the present invention. In an embodiment, the merchant enters a user name, such as an email address, in entry box 202 and an associated password in entry box 204. If the merchant is a new user, by selecting Create Account button 206, the merchant can create a new account to use for setting up an opt in incentive program according to embodiments of the present invention.

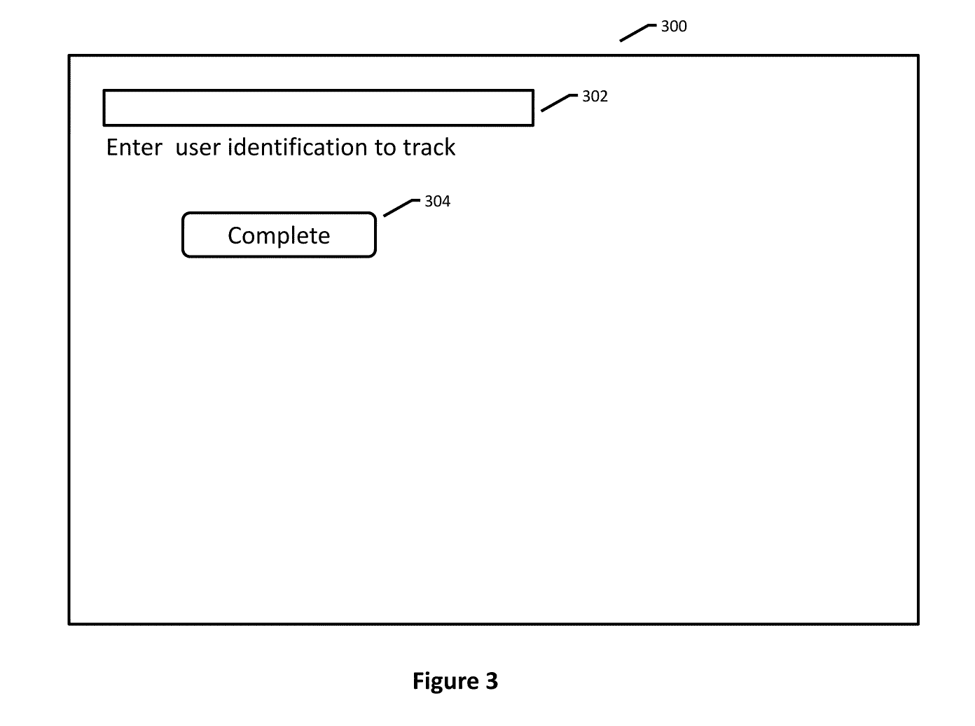

In step 104, unique ID's of the individuals to be tracked are entered. In an embodiment, web site user names are used to uniquely identify individuals for tracking FIG. 3 illustrates an exemplary unique ID entry web page 300 according to an embodiment of the present invention. The user provides a unique ID for an individual in entry box 302, and presses enter. Pressing enter causes the system to store the unique ID in a database. The user can enter as many unique ID's as desired. In an embodiment, entry box 302 is configured as a drop down menu having a list of individuals from which an individual is chosen. Any other method for presenting or selecting individuals to track can be used depending on implementation. When the user is finished, the user presses complete button 304 to exit the unique ID entry screen.

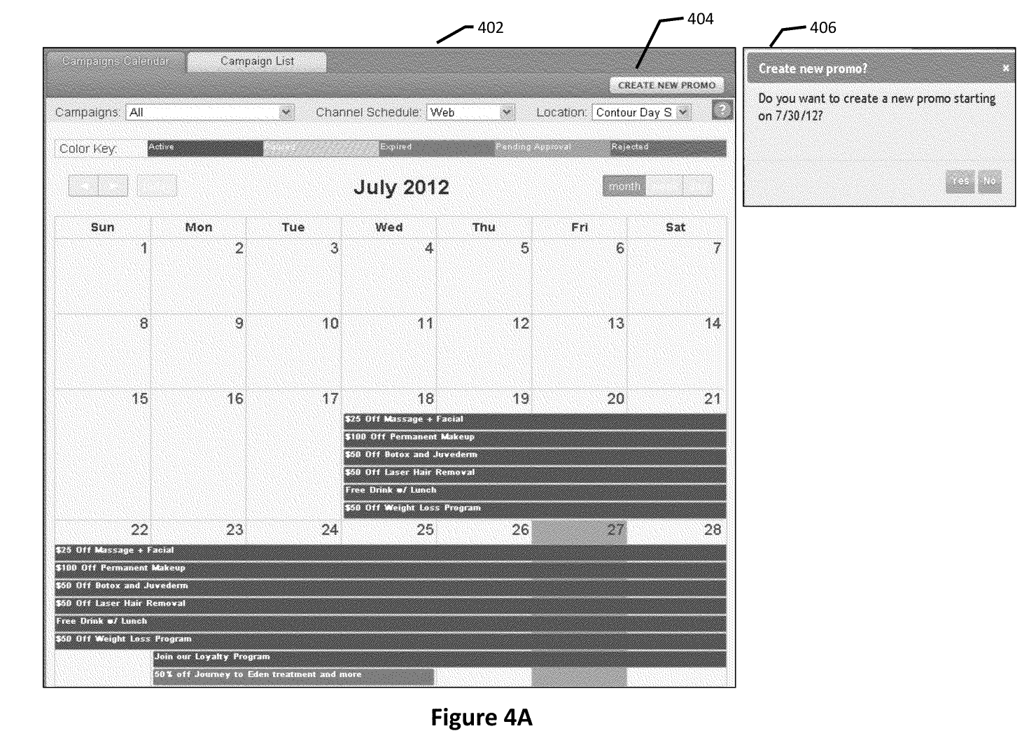

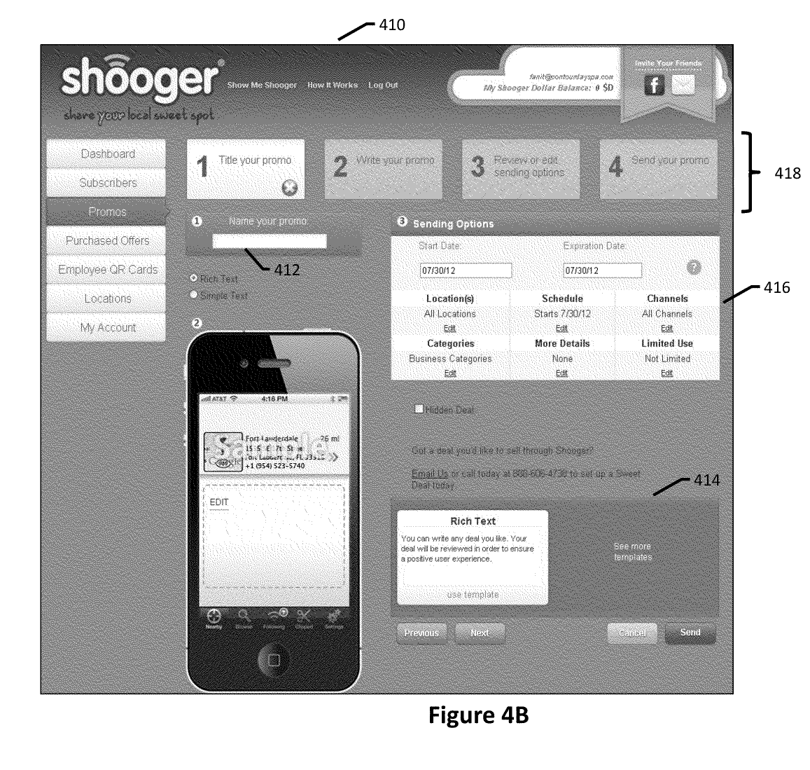

In step 106, the user creates a promotion to use to incentivize consumers to opt in to providing marketing information related to the consumer. Any method for allowing entry of user promotions can be used. For example, in an embodiment, a promotion calendar is used to show current promotions and allow entry of new promotions using. FIG. 4A illustrates an exemplary promotion calendar 402 according to an embodiment. Promotion calendar 402 shows currently existing promotions, and provides a button 404 in which a user can request to enter a new promotion. In an embodiment, when the user requests to create a new promotion, a dialog box 406 prompts the user to enter the date to begin the new promotion, with the current date being the default promotion start date.

Entries in promotion calendar 402 can be color coded (or otherwise differentiated) to indicate status of promotions. For example, unique colors can be used to indicate one or more of active promotions, proposed promotions, expired promotions, pending promotions, rejected promotions, or any other status desired for promotions.

FIG. 4B illustrates an exemplary promotion create web page 410. As shown in FIG. 4B, when creating a promotion, a user can enter a title in promotion title box 412. The user can draft the promotion in promotion text box 414. The user can schedule the promotion to be delivered using promotion sending options box 416. Numerous options are available, including start date for the promotion, end date for the promotion, locations where the promotion is valid, limitations that may be applicable to the promotion, channels for how the promotion is distributed (e.g., email, web page, etc.), and any other options that may be applicable to a particular implementation of an embodiment. In an embodiment, the promotion is scheduled to be sent when a consumer opts in to a particular program.

In an embodiment, a status section 418 tracks status of the promotion creation process through the steps of (1) titling the promotion, (2) writing the promotion, (3) review/editing sending options, and (4) sending the promotion. In an embodiment, each section of the status section is highlighted as a user progresses through the promotion creation process. In an embodiment, the step of the promotion process where the user is currently (e.g., section 412, 414 or 416) can be highlighted as well as the user progresses through the promotion creation process. Further, in an embodiment, a user can select a portion of the status section to be directed to that section of the promotion creation web page 410.

In step 108, the user links the created promotion to one or more individuals that the user desires to actively offer the promotion to consumers. In an embodiment, the promotion is associated with one or more unique IDs entered in step 104, or that have been stored previously.

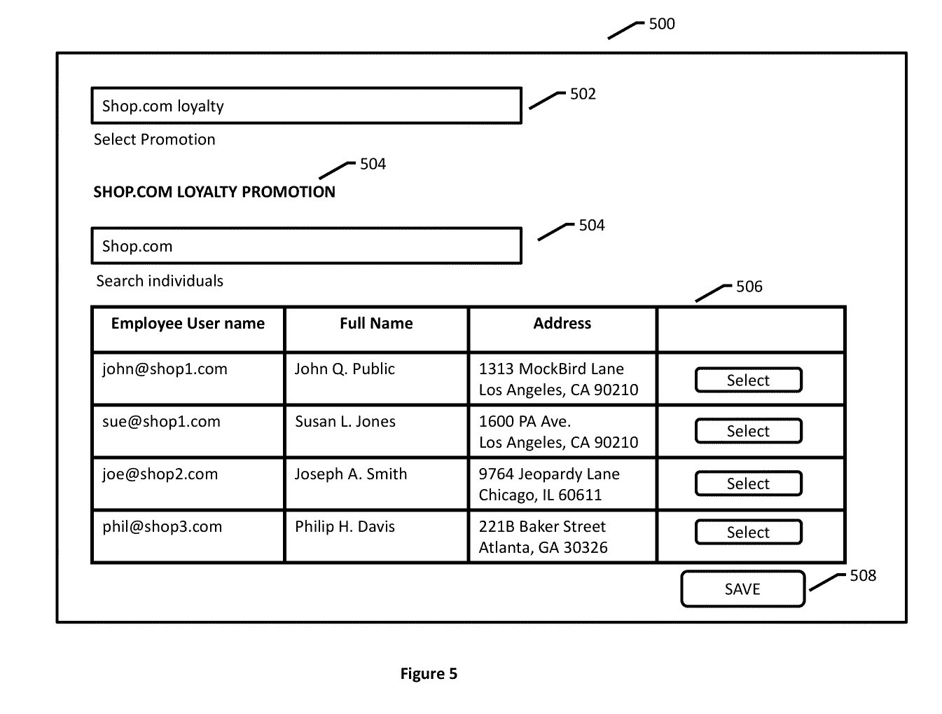

FIG. 5 illustrates a web page 500 for associating promotions with individuals. Once made, the associations can be stored in a database, for example, in a relational manner. Selecting and associating promotions with individuals can be done in any number of ways. For example, as shown in FIG. 5, a user can search for a particular promotion with which to associate or link individuals using search box 502. In an embodiment, search box 502 is implemented as a drop down menu that contains promotions that can be associated to individuals. Any other method for presenting or selecting promotions to associate with individuals can also be used.

In an embodiment, the selected promotion 504 is displayed to the user. Web page 500 also provides the user with the ability to associate individuals with the selected promotion. Any manner of allowing the user to associate individuals with the selected promotion can be used. In an embodiment, for example, a search box 504 is provided. The user provides a criterion for searching for individuals in search box 504. The results of the search, that is, individuals meeting the criteria are presented in results box 506. The user then selects one or more users and saves the selection hitting Save button 508. Hitting save button 508 causes the selected individuals to be associated with the selected promotion. The association can be stored in the database. In an embodiment, individuals can be associated or linked with more than one promotion using web page 500.

In step 110, the system generates unique Universal Resource Locators (URLs) for each individual/promotion association or link. The URLs are used to provide consumers with access to promotions, and to track the performance individuals that provide the URLs to the customers.

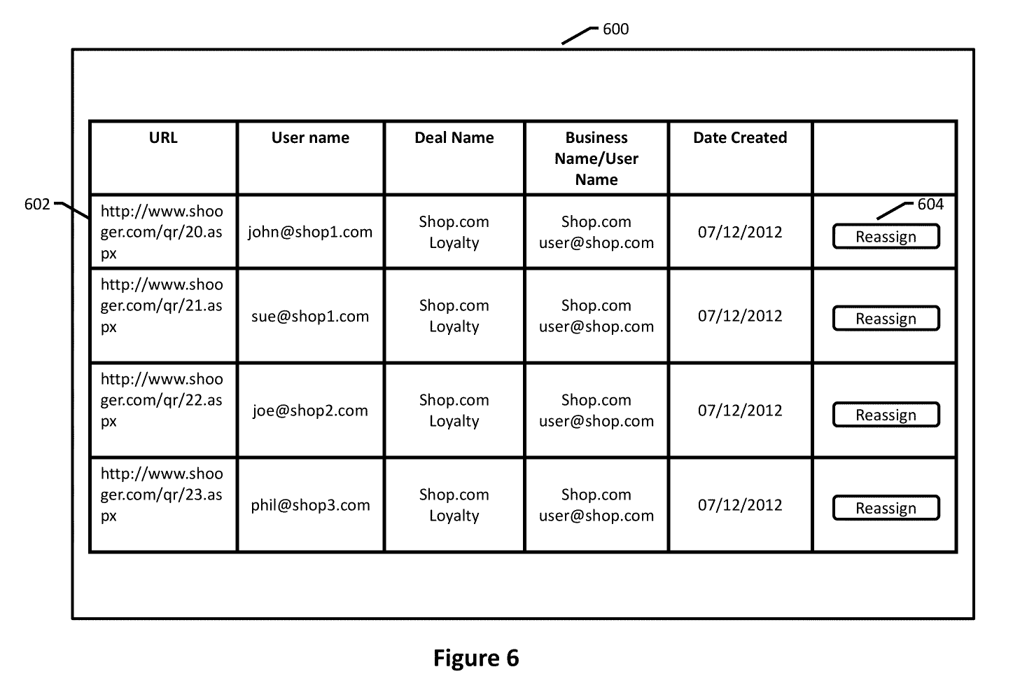

FIG. 6 illustrates an exemplary web page showing system-generated URLs for individual/promotion associations or links. For example, as shown in FIG. 6, in entry 602, the exemplary URL for the john@shop1.com/Sales association is http://shooger.com/x/HiddenDeals/Landing.aspx?qr=195.

As shown in FIG. 6, additional information can be associated with the URLs. For example, as shown in FIG. 6, in an embodiment, the additional information includes, the business name offering the promotion, the user creating the promotion, the date the promotion was created. The additional information can be any information desired for a particular implementation. Also, as illustrated in FIG. 6, URL associations can be reassigned by hitting the reassign button, for example, reassign button 602.

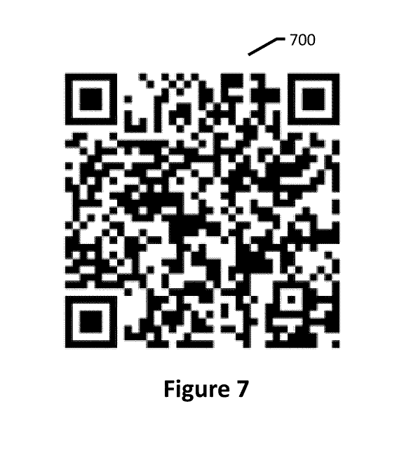

URLs can be distributed to consumers in any manner. However, to facilitate such distribution, in an embodiment, the URLs are converted to QR codes in step 112. The conversion can be by software, hardware, firmware, or any combination thereof. Such conversion from URLs to QR codes is well-known. FIG. 7 illustrates a QR code 700 corresponding to entry 602 with the URL http://shooger.com/x/HiddenDeals/Landing.aspx?qr=195.

In an embodiment, distribution of the QR codes is accomplished by an individual that comes into contact with consumers requesting that a consumer scan the QR code using a QR code reader. Such QR code readers are readily available on many mobile devices including for example, mobile phones, tablets, and other mobile platforms.

In step 114, the QR codes are distributed. To facilitate distribution of QR codes to consumers as well as to remind individuals to distribute the QR codes to consumers, the QR codes are printed on physical media. The QR codes can be found

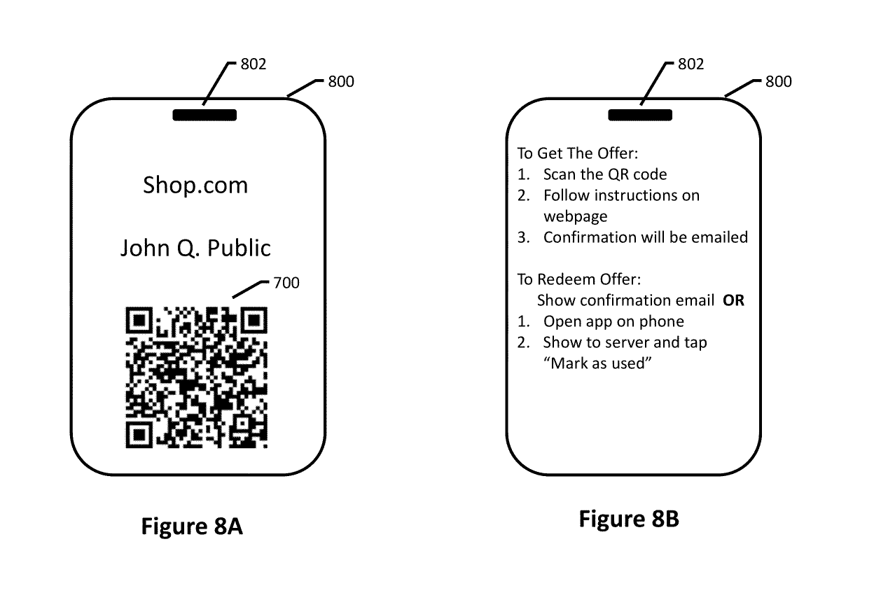

FIG. 8A illustrates a front of an exemplary plastic card 800 having QR Code 700 to be affixed to or worn by an individual by neck lanyard or other connecting device. As can be seen, in an embodiment, the front of card 800 includes QR code 700, identification of the individual to whom the QR code corresponds, and the name of the entity for whom the individual works. More or less information can be included on the front of card 800 as desired depending upon implementation and available space.

FIG. 8B illustrates an exemplary back of card 800. Back of card 800 can include any information desired depending upon implementation and available space. For example, in an embodiment, back of card 800 includes instructions for the individual to explain to the consumer as to how to get an offer. The instructions also indicate that confirmation that the consumer opt in status will be tracked. If the consumer ultimately opts in to the program by obtaining and redeeming the offer, the system will update the individual's performance metrics to so indicate. Such performance records can be stored in a database in association with the individual.

Plastic card 800 also includes a hole 802. The lanyard cord or string or other attaching material is placed through hole 802 in a well known manner.

In step 115, a consumer opt-in is obtained. In an embodiment, when the consumer scans a QR code, such as QR code 700, the consumer is directed to the webpage indicated by the URL encoded in the QR code. The consumer then follows the directions provided on the webpage to opt in to the program for which the promotion is given. For example, the consumer may opt in to a customer loyalty program, and be given a promotion for so opting in. In an embodiment, an application executing on the consumer device that is directed to providing incentives to the consumer, rather than a general web browser, provides the required user interface.

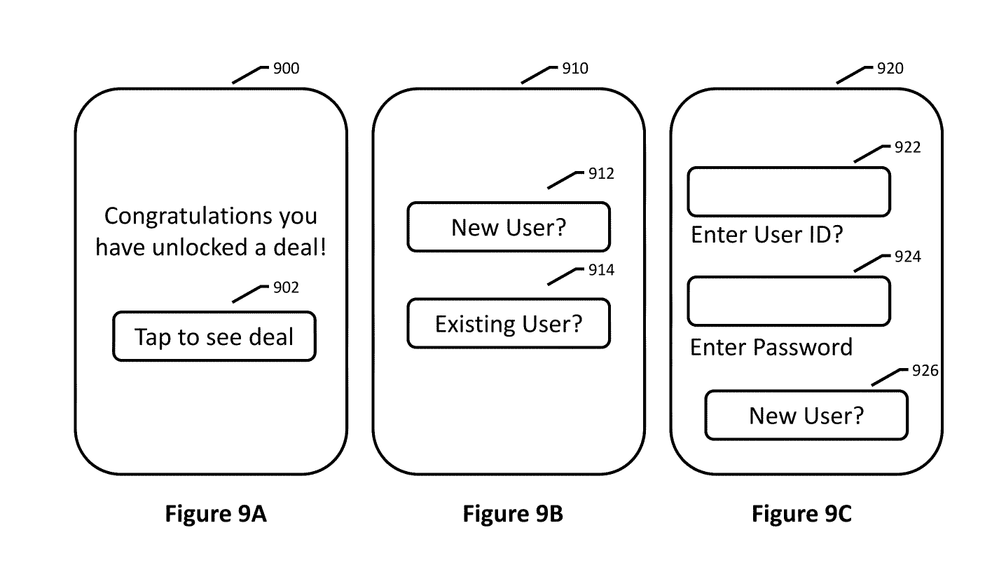

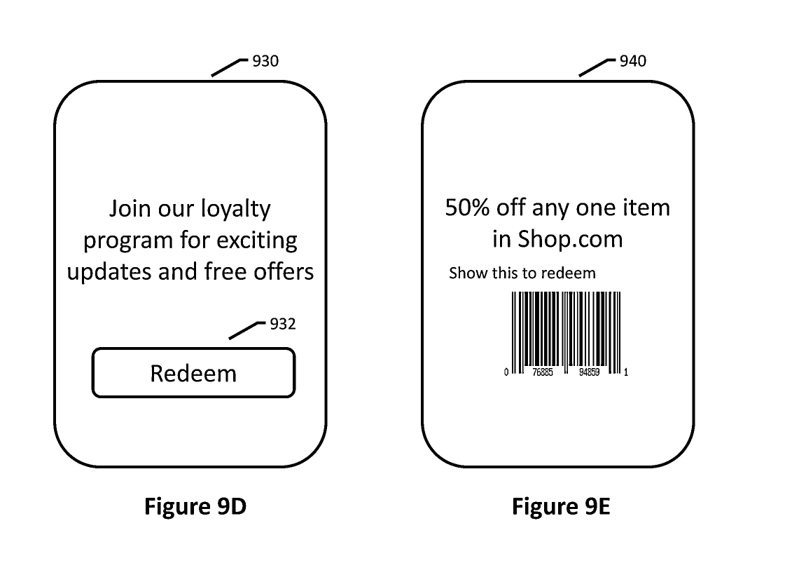

FIGS. 9A-9E illustrate exemplary web pages 900, 910, 920, 930, and 940 that a consumer would see on the mobile device upon scanning a QR code such as QR code 700 according to an embodiment of the present invention. Web pages 900, 910, 920, 930, and 940 are exemplary only, and additional, fewer, and/or different web pages may be presented according to implementation.

Referring to FIG. 9A, when a consumer scans a QR code according to an embodiment, the consumer is directed to web page 900, where the consumer is welcomed and advised he or she has unlocked a deal. To see the deal, the consumer presses button 902. When the consumer presses button 902, the consumer is directed to web page 910 (see, FIG. 9B), where the consumer is asked to confirm whether he or she is a new user or an existing user. If the consumer taps button 912, which indicates the consumer is a new user, the consumer is directed to a registration web page (not shown), where the consumer can enter information to become an existing user. If the consumer taps button 914, which indicates the consumer is an existing user, the consumer is directed to web page 920 (see, FIG. 9C), where the consumer logs in by entering his or her user identification (e.g., email address or other user identification) in text field 922, and corresponding password in text field 924, and then hits a sign in button 926.

Once logged in, the consumer is provided access to the promotion. In an embodiment, the redemption screen is hidden until the user hits a redeem button, thereby accepting the terms of the promotion, for example, joining a customer loyalty program. FIG. 9D illustrates an exemplary consumer promotion page 930 according to an embodiment. As shown in FIG. 9D, consumer promotion page 930 provides some information concerning the promotion. If the consumer desires to accept the promotion, the consumer taps redeem button 932. Upon tapping redeem button 932, the user is directed to a web page that reveals the redemption screen.

In step 116, the system collects performance metrics. For example, the system stores information to indicate that a consumer that the individual presented the QR code to had an interest in the promotion. In an embodiment, this is stored in a one up counter associated with each individual/promotion association that indicates the number of consumers that were indicated an interest in the promotion. Any other desired metrics may be stored and displayed as well.

FIG. 9E illustrates an exemplary reveal promotion web page 940 according to an embodiment. The consumer takes advantage of the promotion by showing a clerk or other individual evidence that the consumer has complied with the requirements for the promotion. For example, as shown in FIG. 9E, in an embodiment, the consumer can take advantage of the promotion by showing the clerk a bar code that is coded to identify the particular promotion the consumer obtained. In addition, the system stores information to indicate that a consumer that the individual presented the QR code to purchased something under the promotion. In an embodiment, this is stored in a one up counter associated with each individual/promotion association that indicates that a consumer purchased a product or service using the promotion. Also, the value of the product or service purchased can be stored as well in a total revenue storage location associated with the individual/promotion association. Any other desired metrics may be stored as well.

In an embodiment, using the stored metrics, such as one-up counters, and revenue storage location, the system can provide reports to the manufacturer or service provider that allows it to track its promotion campaign as well as the performance of employees in publicizing the campaign and signing up consumers to the campaign.

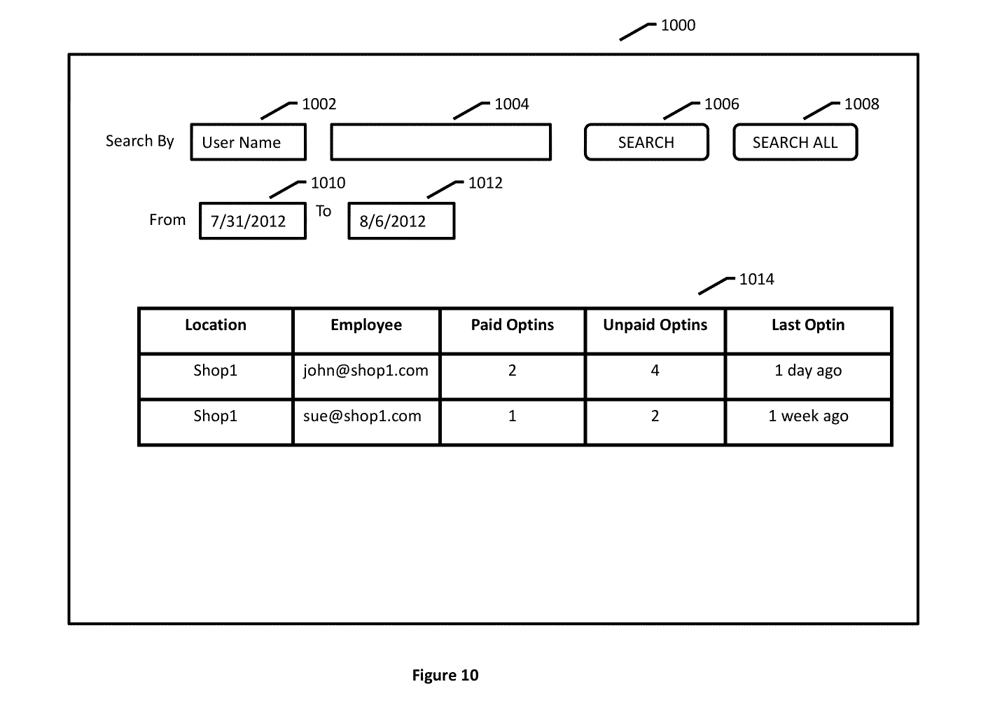

FIG. 10 illustrates an exemplary report web page 1000 showing individual performance according to an embodiment. The employees to track in the report can be identified in any of a number of ways using search by box 1002. For example, the search can be performed by name, location, promotion or any other search criteria for a particular implementation. Wild card characters can be used to broaden search terms. The search term to search is entered in search term box 1004. In an embodiment, the search can be narrowed to a range of dates by entering the start date in start data box 1010 and end date in end date box 1012. When the user has entered the search type in search by box 1002 and the search term in search term box 1004, and any desired dates in boxes start date box 1010 and end date box 1012, the user selects search button 1006. Search button 1006 causes the system to search the database and return for the report those items in the database that match the search criteria. In an embodiment, a report of all items in the database can be returned by selecting search all button 1008.

When the search is performed, the system provides a report showing performance of individuals providing promotions to consumers to entice consumers to act in a certain manner, for example, by opting into a loyalty program, or buying a particular product, or any other behavior. An exemplary such report 1014 is illustrated in FIG. 10. As shown in FIG. 10, in an embodiment, report 1014 includes the employee, the location of the employee, the number of paid (actually joined the program) and unpaid optins (consumer expressed interest in joining program), and the date of the last optin. The date of the last optin can be a relative date (1 day ago, 5 days ago, etc.) or an actual date (Jul. 31, 2012, Aug. 2, 2012, etc.). Any other desired information can be tracked and tabulated in report 1014. For example, revenues generated by consumers opting into a particular program can be tracked, as well as product and/or service purchasing preferences.

Based on these metrics individuals responsible for obtaining consumer opt-ins or purchases can be given awards or other incentives for better performance. In this way, manufacturers and service providers can influence behavior of downstream individuals where they do not have direct control. For example, a manufacturer of a product can influence retail employees by tracking and rewarding their performance in obtaining consumers to participate in manufacturer loyalty programs.

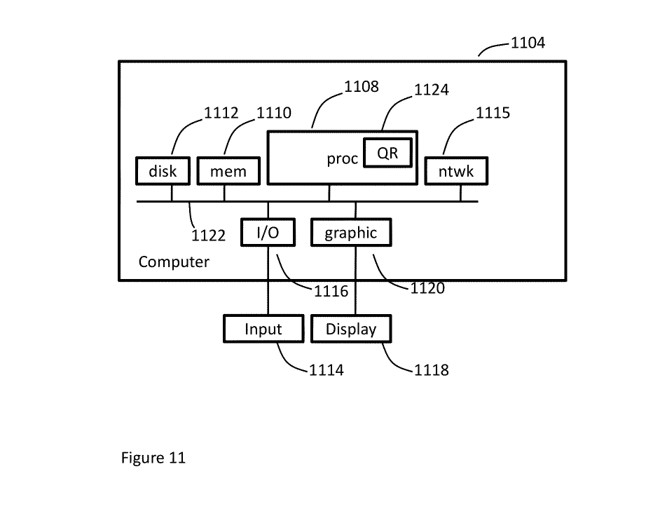

FIG. 11 is a schematic diagram of an exemplary computer 1104 that can be configured to provide the client or server services described herein. In an embodiment, computer 1104 includes a processor 1108 to execute computer programs such as computer programs to carry out the operations described herein. Processor 1108 can be any processor that can execute computer programs to carry out the operations described herein. Processor 1108 can be configured to generate QR codes and/or read data encoded in a QR code format. In addition to software, QR code functionality as described herein can be implemented in hardware, firmware, or any combination of hardware, software, and/or firmware. Computer 1104 includes a memory 1110. In operation, memory 1110 is loaded with a computer program to be executed by processor 1108. Memory 1110 can also store other data, such as scratch pad data and other to be used by processor 1108 during its operation. Memory 1110 can also include a database for storing data and associations as described above. Computer 1104 is also coupled to a storage device 1112. Storage device 1112 can be internal and/or external to computer 1104. Storage device 1112 can be any internal or external storage including, for example, tape drive, CD-ROM, DVD, magnetic disk, or semiconductor disk. More than one storage device 1112 can be present in a particular embodiment.

A bus 1122 provides any required connectivity between processor 1108, memory 1110, and storage device 1112. For example, data can be exchanged between processor 1108, memory 1110, and storage device 1112 over bus 1122. In an embodiment, computer 1104 includes a network adapter 1115. Network adapter 1115 provides connectivity between computer 1115 and other computers.

In an embodiment, computer 1104 for a user may be implemented on a mobile device, such as a mobile telephone, computer tablet, personal digital assistant, or any other mobile communication device. For example, a mobile telephone may have executing thereon a mobile telephone application configured to provide the user with an interface for accepting promotions as described herein. Such computer 1104 for a user as implemented on a mobile device may not have one or more of the components of computer 1104 described with respect to FIG. 1, or may have other components.

An input device 1114 is coupled to bus 1122. In an embodiment, input device 1114 is coupled to bus 1122 through an input/output controller 1116. Input device 1114 can be a keyboard, a pointing device such as a mouse, or any other input device. More than one input device can be present in a particular embodiment. Input device 1114 can also be a camera. Processor 1108 can include a QR scanner 1124 to process a QR code input by the camera. The QR code scanner or image processor can be implemented in software (as shown), hardware, firmware, or any combination thereof. As mentioned above, in an embodiment, or any contact or contactless data transfer method, including without limitation, NFC, RFID, magnetic strip, and other data transfer methods can be employed in place of a QR code input. Any required image processing to convert images or other inputs captured pursuant to these sources can be performed in software, hardware, firmware, or any combination thereof. Input device 1114 can be any combination of input devices to handle any input source. A display 1118 is coupled to bus 1122 through a graphics adapter 1120. Display 118 is used to provide output to a user from computer 1104.

In an embodiment computer 1104 is connected to an external network 1117. For example, in an embodiment, external network 1117 can be the Internet, a telephone network, and/or other communication network. Connectivity to a telephone network can also be by way of telephone switching apparatus (not shown). Connectivity to external network 1117 can be through any combination of wired and/or wireless interfaces appropriate to a particular embodiment, and may include intermediary servers, bridges, and/or routers.

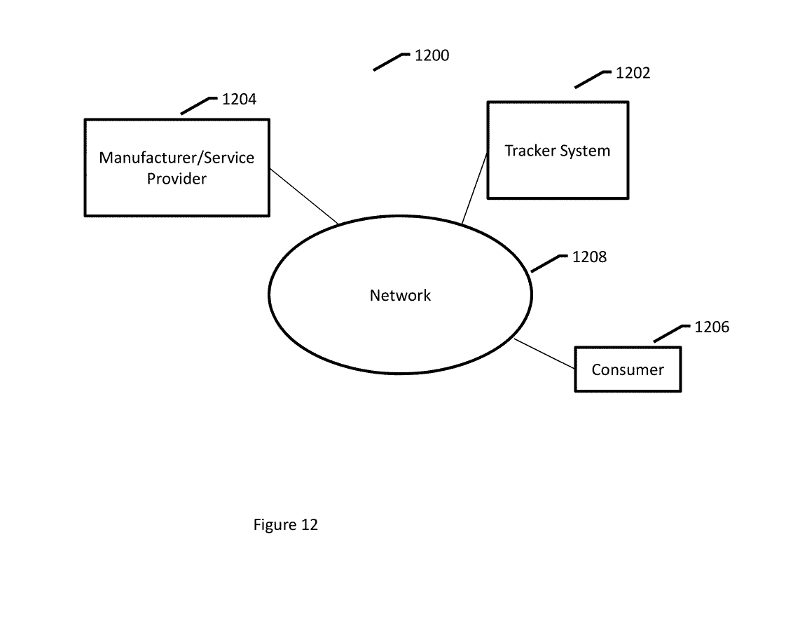

FIG. 12 is a schematic diagram illustrating a system 1200 for tracking individual performance in a promotional campaign according to an embodiment of the present invention. System 1200 includes a tracker system 1202. Tracker system 1202 provides a platform for a user to generate a promotion campaign as described above. The user can use a manufacturer or service provider computer 1204 to generate the campaign and create individual/promotion associations as described above. As described above, tracker system 1202 generate unique URLs and associates them with individuals for storage in a database as described above. A consumer uses a consumer mobile platform 1206 to scan a QR code provided by an individual having contact with the consumer. Tracker system 1202 communicates with consumer mobile platform 1206 to provide web pages so that the user can log in and register to accept the promotion as described above. Consumer mobile platform can be any consumer mobile product, including without limitation, a mobile telephone, a laptop, a tablet, or any other mobile device configured to perform the operations described above. After a consumer log into tracker system 1202 using a QR code, tracker system 1202 updates performance metrics, such as number of unpaid optins, number of paid optins, revenues, and any other desired performance metrics. Tracker system 1202 can use the data to generate reports that can be made available to users using manufacturer or service provider computer 1204.

Connectivity for communications between tracker system 1202, manufacturer or service provider computer 1204, and consumer mobile device 1206 is provided over a network 1216. Network 1216 can be any network or combination of networks. For example, network 1216 can be the Internet, an intranet, a telephone network, a wide area network (WAN), a local area network (LAN), or any combination thereof. Note that the user and consumer can be connected wirelessly over an air interface as well as wired. In an embodiment, any combination of wired and wireless connectivity can be used to provide communication between the system and a user server and the consumer.

In an embodiment, one or more of the display screens can be combined as required for a particular implementation. For example, in an embodiment, FIGS. 3 and 10 are combined in a single display. In another embodiment, FIGS. 5 and 6 are combined in a single display.

In a merchant retail example, a consumer enters a retail establishment such as a salon or restaurant. An employee (individual) approaches the consumer and offers a promotion or discounted purchase in exchange for an opt-in. The consumer then swipes the employee's unique QR code with his mobile phone. The consumer then opts-in directly on his phone by entering his email address and password, and then sees the redemption screen with the promotion redemption instructions. The consumer then displays the redemption screen to the employee or to the cash register checkout clerk and receives his discount. The retail store manager or owner then reviews a report that displays the relative number of opt-ins collected by each of her employees. The store manager then rewards her best performing employees as appropriate.

Another retail example where the consumer does not have an Internet enabled device works as follows: a consumer enters a retail establishment such as a salon. An employee (individual) approaches the consumer and offers a promotion or discounted purchase in exchange for an opt-in. The consumer agrees and the employee swipes his own unique QR code name tag in front of an Internet connected tablet computer located somewhere in the salon. The consumer then opts-in directly on the same tablet computer by entering his email address and password. The consumer then sees the redemption screen with the promotion redemption instructions. The consumer then displays the redemption screen to the employee or to the cash register checkout clerk and receives his discount. The retail store manager or owner then reviews a report that displays the relative number of opt-ins collected by each of her employees. The store manager then rewards her best performing employees as appropriate.

In another embodiment, a manufacturer or service provider, such as Procter and Gamble seeks to incentivize trial or purchase of a particular product or products. In such case, the manufacturer or service provider would compensate a merchant directly by supplying free product samples or by providing rebates on purchases made as part of the opt-in and redemption process. For example, the individual would give away the free product samples or provide rebates as part of the opt-in and redemption process. The individual's performance in giving away product or providing rebates can be tracked as described above.

Ultimately businesses can employ many types of incentive programs in order to motivate Individuals to capture consumer data. But those forms of compensation are left to the discretion of the Business.

The above described embodiments incorporated a QR code for transferring a URL. However, in general any contact or contactless data transfer method, including without limitation, QR codes, NFC, RFID, magnetic strip, and other data transfer methods can be used to generate a unique URL to associate with each product or service for which a promotion is to be offered. Each such data transfer method will include a reader device (e.g., a QR code scanner, an RFID reader, an NFC reader, etc.) to read the URL data to be used as described above.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for tracking performance of individuals providing promotions to consumers, comprising:
(a) a processor configured to accept a promotion and to associate at least one individual with the promotion;
(b) a URL generator to generate a unique URL for the individual associated with the promotion;
(c) a code generator to generate a code based on the generated URL, wherein the code can be scanned by code scanning device;
(d) a code reader to read the generated code;
(e) a webpage provided to the consumer in response to scanning the code to register a consumer for the promotion when the code is read by the reader, wherein the processor is configured to update performance metrics for the individual associated with the URL when the consumer indicates a desire to participate in the promotion via the webpage; and
(f) a report providing one or more of the performance characteristics.

2. The system of claim 1, wherein the report is provided on a display device.

3. The system of claim 1, wherein the code reader is one of a QR code scanner, an RFID reader, an NFC reader, and a magnetic strip reader.

4. The system of claim 1, further comprising a lanyard having the code printed thereon, the lanyard configured to be worn by the individual.

5. The system of claim 1, wherein the code reader is a consumer mobile platform.

6. The system of claim 1, wherein the reader is provided by the individual to the consumer.

7. A method for tracking performance of individuals providing promotions to consumers, comprising:
(a) accepting a promotion through a processor;
(b) associating at least one individual with the promotion;
(c) generating a unique URL for the individual associated with the promotion;
(d) converting the generated URL to a code;
(e) reading the code with a reader device;
(f) providing a webpage to register a consumer for the promotion when the URL is read; by the reader device; and
(g) updating performance metrics for the individual associated with the URL when the consumer indicates a desire to participate in the promotion.

8. The method of claim 7, further comprising displaying performance metrics for at least one individual associate with at least one promotion.

9. The method of claim 7, further comprising reading one of a QR code, an RFID code, and an NFC code.

10. The method of claim 7, printing the code on a lanyard to be worn by the individual.

11. The method of claim 7, further comprising reading the code with a consumer mobile platform.

12. The method of claim 7, further comprising reading the code with a reader provided by the individual to the consumer.
